(19) United States
(12) Patent Application Publication
(10) Pub. No.: US 2010/0122300 A1
(43) Pub. Date: May 13, 2010

(54) INTERACTIVE CONTENT REPRODUCTION

(76) Inventor: Wook-hee MIN, Seoul (KR)

Correspondence Address: North Star Intellectual Property Law, PC, P.O. Box 34688, Washington, DC, 20043, US

(21) Appl. No.: 12/467,334

(22) Filed: May 18, 2009

(30) Foreign Application Priority Data
Nov. 11, 2008 (KR) 10-2008-0111729

(51) Int. Cl. H04N 5/445

(52) U.S. Cl. 725/61

(57) ABSTRACT

In an interactive content reproduction apparatus, user information is stored in the content reproduction apparatus, which is not at a server but at a client, and the content reproduction apparatus selects unit contents of specific levels from among interactive content according to the user information and reproduces a user-adaptive story in which the selected level-specific unit contents are connected in real time or non-real time.

### CROSS-REFERENCE TO RELATED APPLICATION(S)

This application claims the benefit under 35 U.S.C. §119(a) of a Korean Patent Application No. 10-2008-111729, filed Nov. 11, 2008, the disclosure of which is incorporated herein in its entirety by reference.

### BACKGROUND

1. Field

The following description relates to content reproduction technology, and more particularly, to an interactive content reproduction apparatus and method capable of protecting user information.

2. Description of Related Art

Along with the recent paradigm shift in content, has emerged customized-content provision technology that provides different content according to a user. In a conventional network constitution for providing users with customized content, a content providing server selects user-customized content that differs according to a user from among content provided by a content provider, etc., on the basis of user information collected in advance, and transmits it to a content reproduction apparatus of each user.

According to such conventional customized-content provision technology, however, the content providing server collects and stores user information, such as personal information, preference information, and behavior patterns, in advance so as to provide users with customized content.

Lately, technology for providing non-linear content, in which various scenarios can be reproduced according to user input by existing interaction between a user and content, instead of linear content having one scenario, is being vigorously researched.

### SUMMARY

In a first general aspect, an interactive content reproduction apparatus includes a first storage configured to store user information; a second storage configured to store interactive content including a plurality of level-specific unit contents and story map information whereby level-specific unit contents are connected according to a branch condition to constitute a story; and a controller. The controller is configured to select unit contents of respective levels from among the interactive content stored in the second storage according to the user information stored in the first storage, and to reproduce a user-adaptive story in which the selected level-specific unit contents are connected.

Implementations may include one or more of the following features. For example, the interactive content reproduction apparatus may include an output unit configured to output the user-adaptive story reproduced by the controller.

The interactive content reproduction apparatus may include an input unit configured to provide a user interface for inputting user information, and to store the user information input through the user interface in the first storage.

The interactive content reproduction apparatus may include a communicator configured to receive interactive content transmitted from a network through unidirectional communication or bidirectional communication, and to store the interactive content in the second storage.

The second storage may include volatile memory or non-volatile memory.

The controller may include a unit content selector configured to compare a branch condition of a unit content of each level with the user information stored in the first storage and to select a unit content of a lower level; and a reproduction processor configured to reproduce the user-adaptive story in which the level-specific unit contents selected by the unit content selector are connected. The reproduction processor may build the user-adaptive story by connecting the level-specific unit contents selected by the unit content selector, and reproduce the built user-adaptive story in non-real time. The reproduction processor may reproduce the user-adaptive story in real time by sequentially reproducing the level-specific unit contents selected by the unit content selector.

The controller may select a unit content of a specific level according to environmental information. The unit content selector may compare a branch condition of the unit content of the specific level with the environmental information, and select a unit content of a lower level.

The user information may include one or more of age information, sex information, address information, preference information, and behavior pattern information. The environmental information may include one or more of season information, day of the week information, time information, anniversary information, and location information. The interactive content reproduction apparatus may include an information collector configured to collect the preference information or the behavior pattern information included in the user information.

The interactive content reproduction apparatus may include an interrupt processor configured to interrupt reproducing of the user-adaptive story reproduced by the controller when a user interrupt or a system interrupt occurs, and to reproduce specific unit contents or a story built by connecting the unit contents. The interrupt processor may resume or terminate the interrupted story after reproducing the specific unit contents or the story built by connecting the unit contents.

In another general aspect, an interactive content reproduction method includes comparing, at a content reproduction apparatus, a branch condition of a unit content of each level of interactive content with previously stored user information, the interactive content including a plurality of level-specific unit contents and story map information whereby level-specific unit contents are connected according to a branch condition to constitute a story, and selecting a unit content of a lower level; and reproducing a user-adaptive story in which the selected level-specific unit contents are connected.

Implementations can include one or more of the following features. For example, the reproducing of the user-adaptive story may include building the user-adaptive story by connecting the selected level-specific unit contents, and reproducing the built user-adaptive story in non-real time. The reproducing of the user-adaptive story may include reproducing the user-adaptive story in real time by sequentially reproducing the selected level-specific unit contents.

The selecting of the unit content may also include the content reproduction apparatus selecting a unit content of a specific level according to environmental information.

According to an exemplary aspect, user information is stored in a content reproduction apparatus not at a server but at a client, the content reproduction apparatus selects unit contents of respective levels from among interactive content, and reproduces a user-adaptive story in which the selected level-specific unit contents are connected.

According to an additional aspect, the content reproduction apparatus may sequentially select unit contents of each level from among the interactive content, and sequentially reproduce the selected level-specific unit contents, thereby reproducing the user-adaptive story in real time.

According to an additional aspect, the content reproduction apparatus may select unit contents of a specific level from among the interactive content, build a user-adaptive story by connecting the selected level-specific unit content, and reproduce the built user-adaptive story in non-real time.

According to an additional aspect, the content reproduction apparatus may select the unit contents of the specific level from among the interactive content in further consideration of environmental information.

According to an additional aspect, the content reproduction apparatus may select the unit contents of the specific level from among the interactive content in further consideration of a user or system interrupt.

Consequently, user information is stored in the content reproduction apparatus, which is not at the server but at the client, and the content reproduction apparatus reproduces non-linear content, in which various scenarios can be reproduced, on the basis of the user information and/or environmental information, so that user-adaptive content can be provided without leaking the user information.

User information is protected because user information is not collected and stored at the server. The user-adaptive content reproduction technology is capable of providing non-linear content, in which various scenarios can be reproduced according to user input, in a user-customized way without leaking user information.

Other features and aspects will be apparent from the following detailed description, the drawings, and the claims.

### BRIEF DESCRIPTION OF THE DRAWINGS

FIG. 1 is a schematic illustration of exemplary interactive content.

FIG. 2 is a block diagram of an exemplary interactive content reproduction apparatus capable of protecting user information.

FIG. 3 is a flowchart of an exemplary interactive content reproduction procedure capable of protecting user information.

FIG. 4 is a flowchart of an exemplary procedure for reproducing a user-adaptive story in non-real time.

FIG. 5 is a flowchart of an exemplary procedure for reproducing a user-adaptive story in real time.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the media, methods, apparatuses, and systems described herein. Accordingly, various changes, modifications, and equivalents of the media, methods, apparatuses, and systems described herein will be suggested to those of ordinary skill in the art. Also, descriptions of well-known functions and structures may be omitted for increased clarity and conciseness.

In the following description, a detailed description of known functions and configurations incorporated herein will be omitted when it may obscure the subject matter with unnecessary details.

Before describing the exemplary embodiments, terms used throughout this specification are defined. These terms are defined in consideration of functions according to exemplary embodiments, and can be varied according to a purpose of a user or manager, or precedent and so on. Therefore, definitions of the terms should be made on the basis of the overall context.

The term “non-linear content” refers to content enabling interaction with a user and reproduction of various scenarios according to user input.

The term “interactive content” refers to content in which a scenario is changed or various events occur according to user input. Interactive content is included in non-linear content.

The term “unit content” refers to a unit of content constituting interactive content. According to a conditional branch, a unit content is connected with unit contents of lower levels, s thereby forming a story line.

The term “story map information” is information for connecting level-specific unit contents constituting interactive content according to branch conditions.

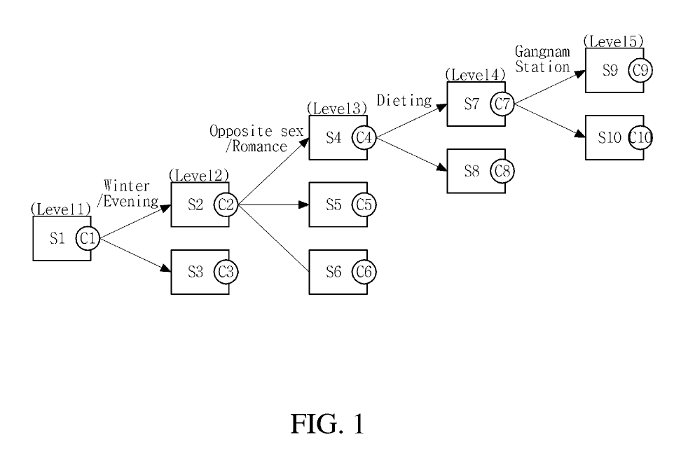

Referring to FIG. 1, level-specific unit contents S1-S10 constituting interactive content are connected with each other according to branch conditions C1-C10, thereby forming various story lines.

When a branch condition C1 of a unit content S1 of level 1 satisfies a condition “winter/evening,” the unit content S1 branches to a unit content S2 of level 2. Here, when a branch condition C2 of the unit content S2 of level 2 satisfies a condition “opposite sex/romance,” the unit content S2 branches to a unit content S4 of level 3.

Further, when a branch condition C4 of the unit content S4 of level 3 satisfies a condition “dieting,” the unit content S4 branches to a unit content S7 of level 4, and, when a branch condition C7 of the unit content S7 of level 4 satisfies a condition “Gangnam Station,” the unit content S7 branches to a unit content S9 of level 5.

In this way, interactive content are connected with each other according to branch conditions, thereby forming various story lines.

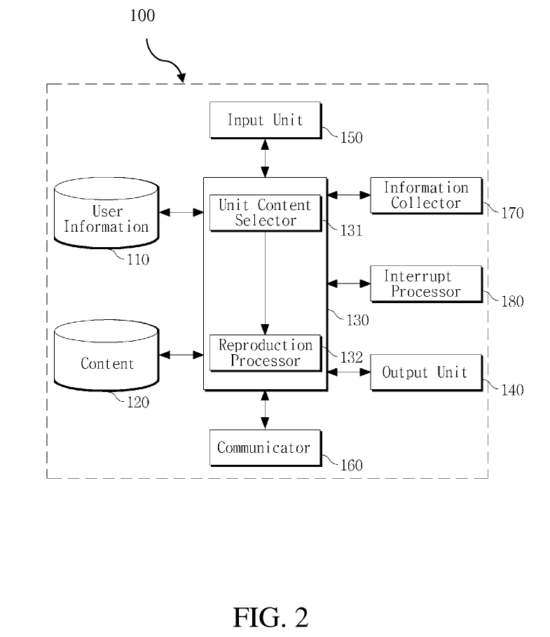

The constitution of a content reproduction apparatus that user-adaptively provides such interactive content without leaking user information is described further with reference to FIG. 2. Referring to FIG. 2, an exemplary interactive content reproduction apparatus 100 capable of protecting user information includes a first storage 110, a second storage 120, and a controller 130.

The first storage 110 stores user information. For example, the user information may include age information, sex information, address information, preference information, behavior pattern information, and so on. Here, the first storage 110 may be a non-volatile memory.

The second storage 120 stores interactive content including a plurality of level-specific unit contents and story map information whereby level-specific unit contents are connected according to branch conditions and constitute a story.

As an example, when interactive content is provided in real time by a server, the second storage 120 may be a volatile memory that buffers the interactive content transmitted in real time.

As another example, when interactive content is received from a server, stored, and reproduced, the second storage 120 may be a non-volatile memory that stores the interactive content.

According to user information stored in the first storage 110, the controller 130 selects unit contents of respective levels from among interactive content stored in the second storage 120 and reproduces a user-adaptive story in which the selected level-specific unit contents are connected.

At this time, the content reproduction apparatus 100 may select unit contents of respective levels from among interactive content, build a user-adaptive story by connecting the selected level-specific unit contents, and reproduce the built user-adaptive story in non-real time.

Alternatively, the content reproduction apparatus 100 may sequentially select level-specific unit contents from among interactive content and sequentially reproduce the selected level-specific unit contents, thereby reproducing a user-adaptive story in real time.

Meanwhile, the controller 130 may include a unit content selector 131 and a reproduction processor 132. The unit content selector 131 compares the branch condition of a unit content of a specific level with user information stored in the first storage 110 and selects a unit content of a lower level.

The reproduction processor 132 reproduces a user-adaptive story in which level-specific unit contents selected by the unit content selector 131 are connected.

At this time, the reproduction processor 132 may reproduce the user-adaptive story in real time by sequentially reproducing the level-specific unit contents selected by the unit content selector 131.

Alternatively, the reproduction processor 132 may build the user-adaptive story by connecting the level-specific unit contents selected by the unit content selector 131, and reproduce the built user-adaptive story in non-real time.

As an example, when the branch condition of a unit content of a specific level deals with age, the controller 130 may select a unit content satisfying an age requirement, such as teens, twenties and thirties, from among unit contents of a lower level branching from the corresponding level with reference to an age included in user information.

As another example, when the branch condition of a unit content of a specific level deals with sex, the controller 130 may select one of unit contents of a lower level branching from the corresponding level according to whether a sex included in user information is male or female.

The controller 130 sequentially reproduces unit contents of an upper level and lower level selected at each level on the basis of such user information, thereby reproducing a user-adaptive story based on user information.

In this way, the user information-protective interactive content reproduction apparatus 100 stores user information in the content reproduction apparatus 100, which is not at a server but at a client, reproduces interactive content that is non-linear content on the basis of the user information, and thus can provide user-adaptive content without leaking the user information.

For example, let us assume that interactive content is advertising content sequentially branching according to branch conditions including region, age and sex, and, according to user information, a user is a female in her twenties living in Seoul Gangnam.

By the user information-protective interactive content reproduction apparatus 100, a unit content satisfying a condition “Seoul Gangnam” is selected at a second level after a unit content of a first level.

After the unit content of the second level, a unit content of a third level satisfying a condition “twenties” is selected, and after the unit content of the third level, a unit content of a fourth level satisfying condition “female” is finally selected. In this way, an appropriate advertising story for the user is built and reproduced, and thus user-adaptive interactive content is provided without leaking user information.

The user information-protective interactive content reproduction apparatus 100 can provide user-adaptive interactive content, not only in advertisement, but in various fields including education and news.

According to an additional aspect, the user information-protective interactive content reproduction apparatus 100 may further include an output unit 140. The output unit 140 outputs a user-adaptive story reproduced by the controller 130. When the interactive content is video content, the output unit 140 may be a display means such as a liquid crystal display (LCD) for displaying the content.

On the other hand, when the interactive content is audio content, the output unit 140 may be an audio output means such as a speaker for outputting the content. As another example, if the interactive content is multimedia content including both video and audio, the output unit 140 may include both of a display means and an audio output means to output the multimedia content.

The output unit 140 may be implemented in one apparatus together with the first storage 110, the second storage 120 and the controller 130, or implemented in different apparatuses.

As an example, when interactive content is provided by a third-generation mobile telecommunication terminal capable of reproducing multimedia content, the first storage 110, the second storage 120, the controller 130 and the output unit 140 may be implemented in the mobile telecommunication terminal.

As another example, when interactive content is provided by an Internet protocol television (IPTV) system, the first storage 110, the second storage 120 and the controller 130 of s the user information-protective interactive content reproduction apparatus 100 may be implemented in a set-top box, and the output unit 140 may be implemented in a TV set connected with the set-top box.

According to an additional aspect, the user information-protective interactive content reproduction apparatus 100 may further include an input unit 150. The input unit 150 provides a user interface (UI) for inputting user information and stores user information input through the UI in the first storage 110.

In other words, the user information-protective interactive content reproduction apparatus 100 that is a client apparatus receives user information from a user and stores it in the first storage 110 in order to provide user-adaptive interactive content without leaking user information.

Accordingly, the user information-protective interactive content reproduction apparatus 100 adoes not provide user information input by a user to a server providing interactive content but stores it in the user information-protective interactive content reproduction apparatus 100 itself that is the user's client apparatus, thereby preventing damage caused by personal information leakage.

The user information-protective interactive content reproduction apparatus 100 may further include a communicator 160. The communicator 160 receives interactive content transmitted from a network through unidirectional communication or bidirectional communication, and stores it in the second storage 120.

In other words, the interactive content reproduction apparatus 100 receives interactive content from a network and stores it in the apparatus itself. Interactive content created by a content provider, for example, is transmitted from a content providing server to the user information-protective interactive content reproduction apparatus 100 through unidirectional communication or bidirectional communication in response to a request from the user information-protective interactive content reproduction apparatus 100. The communicator 160 receives and stores the interactive content in the second storage 120.

The controller 130 of the user information-protective interactive content reproduction apparatus 100 may select a unit content of a specific level according to environmental information. For example, the environmental information may include one or more of season information, day of the week information, time information, anniversary information, and location information, for example.

Here, the unit content selector 131 of the controller 130 may be implemented to compare the branch condition of a unit content of a specific level with environmental information and select a unit content of a lower level.

The controller 130 of the user information-protective interactive content reproduction apparatus 100 selects a unit content of a specific level in consideration of environmental information as well as user information, and thus more user-adaptive content can be provided.

The environmental information can be detected by the user information-protective interactive content reproduction apparatus 100.

As an example, day of the week information and time information among the environmental information can be detected by a task module of the user information-protective interactive content reproduction apparatus 100 that manages the date and hour.

As another example, season information and anniversary information among the environmental information can be detected by a task module of the user information-protective interactive content reproduction apparatus 100 that manages a calendar.

As yet another example, location information among the environmental information can be detected by a task module of the user information-protective interactive content reproduction apparatus 100 that manages a location.

According to an additional aspect, the user information-protective interactive content reproduction apparatus 100 may further include an information collector 170. The information collector 170 collects preference information or behavior pattern information included in the user information.

Thus, the user information-protective interactive content reproduction apparatus 100 automatically collects preference information or behavior pattern information included in user information.

For example, the user information may include one or more of age information, sex information, address information, preference information, behavior pattern information, for example. The preference information and the behavior pattern information may be input from a user, or collected by monitoring a user's behavior for a specific time period.

As an example, the information collector 170 may collect preference information by monitoring a website access history of the user information-protective interactive content reproduction apparatus 100 that a user carries. In this case, the user information-protective interactive content reproduction apparatus 100 would need to have a web access function.

As another example, the information collector 170 may collect behavior pattern information by monitoring the location of the user information-protective interactive content reproduction apparatus 100 that a user carries. In this case, the user information-protective interactive content reproduction apparatus 100 would need to have a function of calculating location information using a global positioning system (GPS) transmitter/receiver module, etc.

The user information-protective interactive content reproduction apparatus 100 may further include an interrupt processor 180. The interrupt processor 180 interrupts story reproduction in response to user request or a system request (a system interrupt) while a user-adaptive story is reproduced by the controller 130, and reproduces specific unit contents or a story built by connecting the specific unit contents.

After reproducing the specific unit contents or the story built by connecting them, the interrupt processor 180 resumes or terminates the interrupted story.

Therefore, planned specific unit contents or a story built by connecting them are selected and reproduced by a user or system interrupt, that is, a user request or system request, as well as conditional branching whereby a unit content of an upper level is connected with a unit content of a lower level according to a condition. Otherwise, in response to a user or system interrupt as well as conditional branching, a unit content according to another condition is selected at the same level and a story is reproduced continuously, or a unit content is selected by jumping from one level to another level and a story is reproduced continuously.

In this way, specific content can be reproduced according to a user or system request. For example, when a user performs a specific input while the user information-protective interactive content reproduction apparatus 100 is reproducing user-adaptive advertising content, the interrupt processor 180 may interrupt reproduction of the user-adaptive advertising content and reproduce billing content for introducing and purchasing an advertising product.

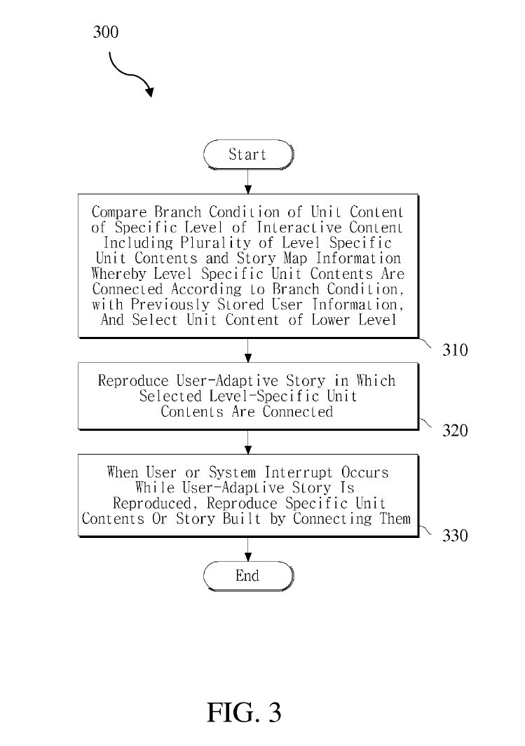

A user information-protective interactive content reproduction operation of the above-described user information-protective interactive content reproduction apparatus 100 is described below with reference to FIG. 3.

FIG. 3 is a flowchart of an exemplary interactive content reproduction procedure 300 capable of protecting user information. In operation 310, the content reproduction apparatus 100 compares a branch condition of a unit content of a specific level of interactive content with previously stored user information, thereby selecting a unit content of a lower level. The specific level of interactive content includes a plurality of level-specific unit contents and story map information whereby level-specific unit contents are connected according to branch conditions and constitute a story.

In operation 310, the content reproduction apparatus may further select a unit content of a specific level according to environmental information. For example, the user information may include one or more of age information, sex information, address information, preference information, behavior pattern information, for example, and the environmental information may include one or more of season information, day of the week information, time information, anniversary information, location information, for example.

In other words, in operation 310, the content reproduction apparatus 100 sequentially compares a branch condition of each unit content from the first level of interactive content to last level with user information stored in the content reproduction apparatus itself in advance and/or environmental information detected by the content reproduction apparatus, and selects unit contents of lower levels to which the story branches, thereby extracting unit contents of respective levels to constitute a user-adaptive story.

An example in which the content reproduction apparatus selects a unit content of each level of interactive content is described with reference to FIG. 1. Let us assume that age information included in user information is 23, sex information is female, friend information is that she is in a romantic relationship, and preference information includes “dieting,” and season information included in environmental information detected by the content reproduction apparatus is winter, location information about an appointment location is a hamburger restaurant near Gangnam Station, and appointment time information is 7 pm.

According to story map information, the branch condition C1 of the unit content S1 of level 1 conditionally branches depending on the season and time. The content reproduction apparatus selects the unit content S2 of level 2 depending on the season information and appointment time information included in the environmental information. For example, the unit content S1 may be a scene image of an appointment, and the unit content S2 of level 2 may be a background image of winter/evening.

According to story map information, the branch condition C2 of the unit content S2 of level 2 conditionally branches depending on whether or not a friend exists. The content reproduction apparatus selects the unit content S4 of level 3 depending on the friend information included in the user information. For example, the unit content S4 of level 3 may be a sweet music.

According to story map information, the branch condition C4 of the unit content S4 of level 3 conditionally branches depending on a preference. The content reproduction apparatus selects the unit content S7 of level 4 depending on the preference information included in the user information. For example, the unit content S7 of level 4 may be an advertising image of a vegetable burger advantageous for dieters.

According to story map information, the branch condition C7 of the unit content S7 of level 4 conditionally branches depending on an appointment location. The content reproduction apparatus selects the unit content S9 of level 5 depending on the location information about the appointment location included in the user information. For example, the unit content S9 of level 5 may be guide information about hamburger restaurants near Gangnam Station. In this way, user-adaptive unit contents are selected from among unit contents of respective levels of interactive content according to user information and/or environmental information.

Subsequently, in operation 320, the content reproduction apparatus 100 reproduces a user-adaptive story in which the level-specific unit contents selected in operation 310 are connected.

In operation 320, the content reproduction apparatus 100 may build the user-adaptive story by connecting the level-specific unit contents selected in operation 310 and reproduce the built user-adaptive story in non-real time.

Alternatively, in operation 320, the content reproduction apparatus 100 may reproduce the user-adaptive story in real time by sequentially reproducing the level-specific unit contents selected in operation 310.

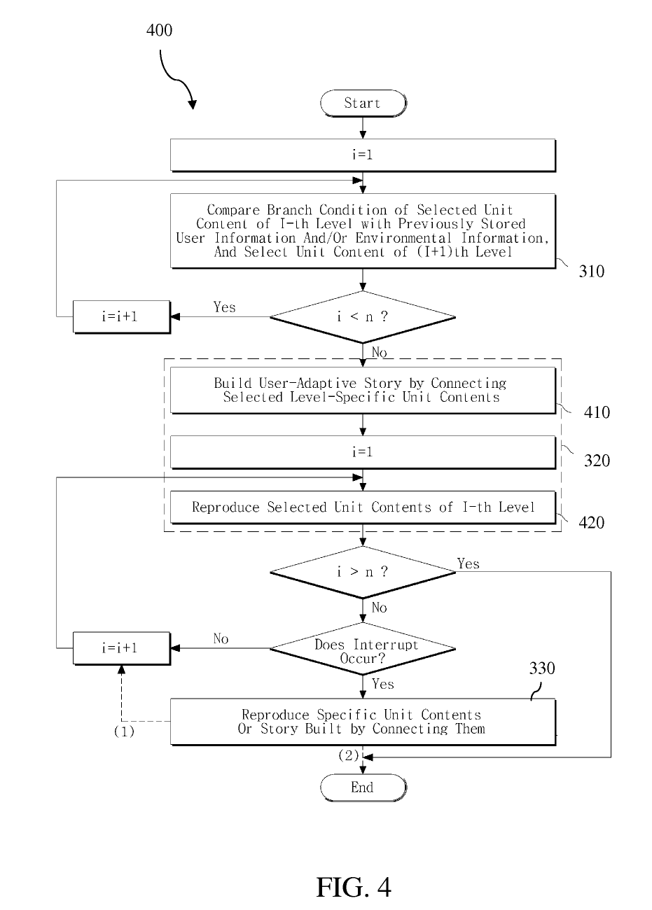

FIG. 4 is a flowchart of an exemplary procedure 400 for reproducing a user-adaptive story in non-real time. When the level-specific unit contents are selected in operation 310, the user-adaptive story in which the selected level-specific unit contents are connected is reproduced in operation 320. In operation 410, the content reproduction apparatus builds the user-adaptive story by connecting the level-specific unit contents selected in operation 310. More specifically, in operation 410, the level-specific unit contents selected in operation 310 are connected in level order so as to constitute the user-adaptive story.

Subsequently, in operation 420, the content reproduction apparatus reproduces the user-adaptive story built in operation 410. More specifically, in operation 420, the level-specific unit contents from the unit content of the first level to the unit content of the last level constituting the user-adaptive story are reproduced in level order, and thus the user-adaptive story is reproduced in non-real time.

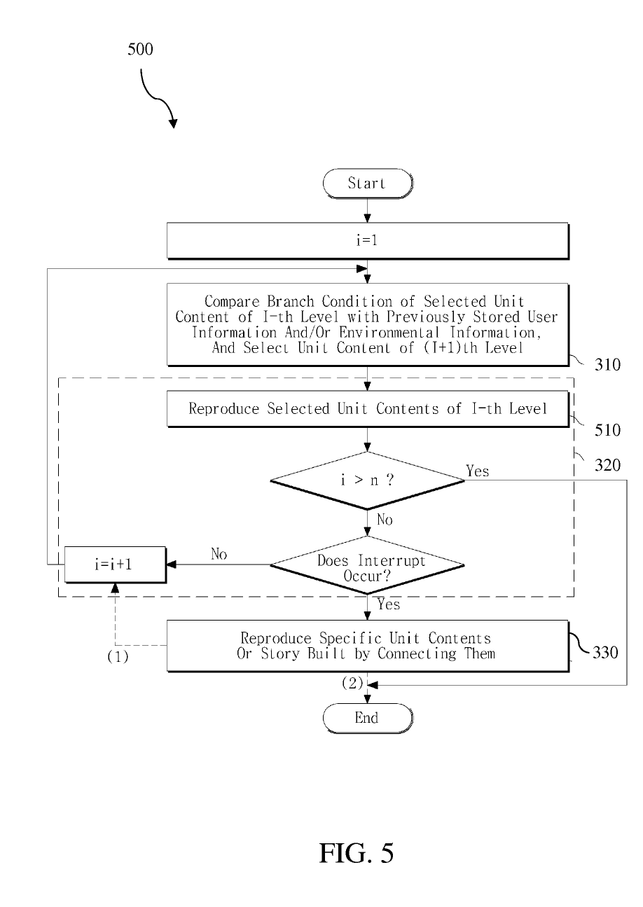

FIG. 5 is a flowchart of an exemplary procedure 500 for reproducing a user-adaptive story in real time. When the level-specific unit contents are selected in operation 310, the user-adaptive story in which the selected level-specific unit contents are connected is reproduced in operation 320. In operation 510, the content reproduction apparatus reproduces the user-adaptive story in real time by sequentially reproducing the level-specific unit contents selected in operation 310.

If the interactive content is video content, then the content reproduction apparatus 100 processes a video output to reproduce the user-adaptive story. On the other hand, if the interactive content is audio content, the content reproduction apparatus 100 processes an audio output to reproduce the user-adaptive story. Additionally, if the interactive content is multimedia content including both video and audio, the content reproduction apparatus 100 outputs the video and audio of the multimedia content to reproduce the user-adaptive story.

In this way, user information is stored in the content reproduction apparatus 100 not of a server but of a client, and the content reproduction apparatus 100 reproduces interactive content that is non-linear content, in which various scenarios can be reproduced, on the basis of the user information and/or environmental information, so that user-adaptive content can be provided without leaking the user information.

According to an additional aspect, when a user or system interrupt is detected during operation 320 of reproducing the user-adaptive story in the user information-protective interactive content reproduction method, the content reproduction apparatus 100 may interrupt story reproduction and reproduce specific unit contents or a story built by connecting them in operation 330.

In operation 330 of reproducing the specific unit contents or the story built by connecting them according to the user or system interrupt, the content reproduction apparatus 100 may (1) resume or (2) terminate the interrupted story after reproducing the specific unit contents or the story built by connecting them.

In other words, planned specific unit contents or a story built by connecting them are selected and reproduced by a user or system interrupt, that is, a user request or system request, as well as conditional branching whereby a unit content of an upper level is connected with a unit content of a lower level according to a condition. Otherwise, by a user or system interrupt as well as conditional branching, a unit content according to another condition is selected at the same level and a story is reproduced continuously, or a unit content is selected by jumping from one level to another level and a story is reproduced continuously.

According to certain examples described above, user information is stored in a content reproduction apparatus not of a server but of a client, and the content reproduction apparatus selects user-adaptive unit contents at respective levels of interactive content on the basis of user information and/or environmental information, so that user-adaptive content can be provided without leaking the user information.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An interactive content reproduction apparatus comprising:
a first storage configured to store user information;
a second storage configured to store interactive content including a plurality of level-specific unit contents and story map information whereby level-specific unit contents are connected according to a branch condition to constitute a story; and
a controller configured to select unit contents of respective levels from among the interactive content stored in the second storage according to the user information stored in the first storage, and to reproduce a user-adaptive story in which the selected level-specific unit contents are connected.

2. The interactive content reproduction apparatus of claim 1, further comprising an output unit configured to output the user-adaptive story reproduced by the controller.

3. The interactive content reproduction apparatus of claim 1, further comprising an input unit configured to provide a user interface for inputting user information, and to store the user information input through the user interface in the first storage.

4. The interactive content reproduction apparatus of claim 1, further comprising a communicator configured to receive interactive content transmitted from a network through unidirectional communication or bidirectional communication, and to store the interactive content in the second storage.

5. The interactive content reproduction apparatus of claim 1, wherein the second storage is a volatile memory.

6. The interactive content reproduction apparatus of claim 1, wherein the second storage is a non-volatile memory.

7. The interactive content reproduction apparatus claim 1, wherein the controller comprises:
a unit content selector configured to compare a branch condition of a unit content of each level with the user information stored in the first storage and to select a unit content of a lower level; and
a reproduction processor configured to reproduce the user-adaptive story in which the level-specific unit contents selected by the unit content selector are connected.

8. The interactive content reproduction apparatus of claim 7, wherein the reproduction processor builds the user-adaptive story by connecting the level-specific unit contents selected by the unit content selector, and reproduces the built user-adaptive story in non-real time.

9. The interactive content reproduction apparatus of claim 7, wherein the reproduction processor reproduces the user-adaptive story in real time by sequentially reproducing the level-specific unit contents selected by the unit content selector.

10. The interactive content reproduction apparatus of claim 7, wherein the controller selects a unit content of a specific level according to environmental information.

11. The interactive content reproduction apparatus of claim 10, wherein the unit content selector compares a branch condition of the unit content of the specific level with the environmental information, and selects a unit content of a lower level.

12. The interactive content reproduction apparatus of claim 7, wherein the user information includes one or more of age information, sex information, address information, preference information, and behavior pattern information.

13. The interactive content reproduction apparatus of claim 10, wherein the environmental information includes one or more of season information, day of the week information, time information, anniversary information, and location information.

14. The interactive content reproduction apparatus of claim 12, further comprising an information collector configured to collect the preference information or the behavior pattern information included in the user information.

15. The interactive content reproduction apparatus of claim 1, further comprising an interrupt processor configured to interrupt reproducing of the user-adaptive story reproduced by the controller when a user interrupt or a system interrupt occurs, and to reproduce specific unit contents or a story built by connecting the unit contents.

16. The interactive content reproduction apparatus of claim 15, wherein the interrupt processor resumes or terminates the interrupted story after reproducing the specific unit contents or the story built by connecting the unit contents.

17. An interactive content reproduction method comprising:
comparing, at a content reproduction apparatus, a branch condition of a unit content of each level of interactive content with previously stored user information, the interactive content including a plurality of level-specific unit contents and story map information whereby level-specific unit contents are connected according to a branch condition to constitute a story, and selecting a unit content of a lower level; and
reproducing a user-adaptive story in which the selected level-specific unit contents are connected.

18. The interactive content reproduction method of claim 17, wherein the reproducing of the user-adaptive story comprises building the user-adaptive story by connecting the selected level-specific unit contents, and reproducing the built user-adaptive story in non-real time.

19. The interactive content reproduction method of claim 17, wherein the reproducing of the user-adaptive story comprises reproducing the user-adaptive story in real time by sequentially reproducing the selected level-specific unit contents.

20. The interactive content reproduction method of claim 17, wherein the selecting of the unit content further comprises the content reproduction apparatus selecting a unit content of a specific level according to environmental information.
